(19) United States
(12) Patent Application Publication
(10) Pub. No.: US 2009/0140546 A1
(43) Pub. Date: Jun. 4, 2009

(54) VEHICLE BODY FRONT STRUCTURE

(75) Inventors: Kojiro Okabe, Wako-shi (JP); Shigeto Yasuhara, Wako-shi (JP)

Correspondence Address: RANKIN, HILL & CLARK LLP, 38210 Glenn Avenue, WILLOUGHBY, OH, 44094-7808, US

(73) Assignee: HONDA MOTOR CO., LTD., Tokyo (JP)

(21) Appl. No.: 12/328,108

(22) Filed: Dec. 4, 2008

(30) Foreign Application Priority Data
Dec. 4, 2007 (JP) 2007-313772

(51) Int. Cl. B60J 9/00

(52) U.S. Cl. 296/187.09

(57) ABSTRACT

A vehicle body front structure wherein impact absorbers are provided on front side frames and a bumper beam is provided to the impact absorbers. The bumper beam has high-strength parts in the rear halves of the left and right ends. The high-strength parts are supported by internal impact absorbers and external impact absorbers.

### FIELD OF THE INVENTION

The present invention relates to a vehicle body front structure in which impact absorbers are provided to front side frames, and a bumper beam is provided to the impact absorbers.

### BACKGROUND OF THE INVENTION

Japanese Patent Application Laid-Open Publication No. 2007-190964 (JP 2007-190964 A) discloses a vehicle body front structure comprising upper members on the external sides of front side frames with respect to a vehicle body, wherein internal and external impact absorbers are provided at the front ends of the front side frames and the upper members, and a bumper beam is mounted on the internal and external impact absorbers.

FIG. 1 hereof shows the vehicle body front structure disclosed in JP 2007-190964 A.

In a vehicle body front structure 200, the lateral width of the impact absorbers is increased by providing internal and external impact absorbers 203, 204 to the front ends of a left front side frame 201 and a left upper member 202.

When an impact load f acts on a bumper beam 205, the internal and external impact absorbers 203, 204 are prevented from transversely deforming, and the acting impact load f is transmitted to the left front side frame 201 and the left upper member 202 via the internal and external impact absorbers 203, 204.

In the vehicle, the left and right front corners of the vehicle are formed into comparatively large curving shapes in order to improve the outward appearance of the vehicle.

To form the left and right front corners of the vehicle into a comparatively large curving shape, a considered possibility is to form a concave part 206 (shown by a faded line) in the front part of an end 205a of the bumper beam 205.

However, when a concave part 206 is formed in the front part of the end 205a of the bumper beam 205, it is difficult to ensure rigidity in the end 205a.

In the vehicle body front structure 200, when another vehicle 201 is misaligned to the left and collides in an offset manner the bumper beam 205 deforms as shown by a faded line.

The deformation of the bumper beam 205 causes the impact load to act on the left bumper beam 205 toward the vehicle width center, as shown by the arrow a. The impact load acts on the left front side frame 201 and exerts force that would bendably deform the left front side frame 201 as shown by the arrow b.

The front part of the end 205a of the bumper beam 205 is formed into a concave part 206, and the rigidity of the end 205a is reduced. Consequently, it is difficult to integrally link together the internal and external impact absorbers 203, 204, and the internal and external impact absorbers 203, 204 deform individually. Therefore, the left front side frame 201 bendably deforms as shown by the arrow b, and it is believed that the impact load cannot be efficiently absorbed.

### SUMMARY OF THE INVENTION

An object of the present invention is to provide a vehicle body front structure in which left and right front corners of a vehicle can be formed into comparatively large curving shapes and impact loads can be efficiently absorbed.

According to an aspect of the present invention, there is provided a vehicle body front structure comprising: left and right front side frames extending in a longitudinal direction of a vehicle body; left and right front pillars disposed above the respective left and right front side frames and extending rearwardly; left and right upper members extending forward from the respective left and right front pillars and positioned outside the respective left and right front side frames; left and right internal impact absorbers and left and right external impact absorbers provided at respective front ends of the left and right front side frames and the left and right upper members; and a bumper beam provided at front ends of the left and right internal and external impact absorbers, wherein the bumper beam includes: left and right ends curved rearwardly of the vehicle body; high-strength parts provided at rear halves of the left and right ends; and weakened parts formed at front parts of the left and right ends and extending outwardly from areas corresponding to internal walls of the left and right internal impact absorbers, and wherein the high-strength parts of the left and right ends are supported by the internal impact absorbers and the external impact absorbers.

Thus, the high-strength parts are provided to the rear halves of the bumper beam while the high-strength parts of the left and right ends are supported by the internal and external impact absorbers.

When, for example, another vehicle collides in an offset manner at a misalignment to the left or right of the vehicle body front structure or collides with the entire surface of the vehicle body front structure, the deformation of the bumper beam causes the impact load to act on the left end of the bumper beam toward the vehicle width center. The impact load acts on a front side frame, exerting force to bendably deform the left front side frame.

However, the high-strength parts in the rear halves are supported by the internal and external impact absorbers. Consequently, the internal and external impact absorbers can be firmly integrated in the rear halves having the high-strength parts. Thus, by integrating the internal and external impact absorbers, the internal and external impact absorbers do not deform even when subjected to an impact load acting toward the vehicle width center. Therefore, the front side frames can be satisfactorily deformed (specifically, satisfactorily deformed so as to crumple) to efficiently absorb the impact load.

Particularly, when the entire surface of the vehicle body front structure undergoes a collision, the following effects can be obtained in addition to the effects previously described.

Specifically, when the entire surface of the vehicle body front structure undergoes a collision, first, the center of the bumper beam, which is curved toward the front of the vehicle body, deforms toward the rear of the vehicle body to absorb a portion of the impact load. The bumper beam is pushed in between the left and right internal impact absorbers.

Next, the left and right weakened parts of the bumper beam deform (crumple), as do the internal and external impact absorbers disposed on the left and right, absorbing the remainder of the impact load.

In this state, the bumper beam deforms in a straight line substantially parallel to the vehicle width direction, and incomplete crumpling of the left and right weakened parts of the bumper beam can be prevented. A large effective stroke for absorbing the impact load can thereby be ensured, and this design can be effectively applied to the impact-absorbing structure of a vehicle having a short vehicle body front part.

Preferably, the weakened parts are formed by cutting out the front parts of the left and right ends. Consequently, the left and right ends of the bumper beam can be made to approach the vehicle body, and the left and right ends of a bumper face provided on the front of the bumper beam can be made to approach the vehicle body. The bumper face is a member for forming the external side of the vehicle body. Thus, by making the left and right ends of the bumper face approach the vehicle body, the left and right front corners of the vehicle can be formed into a comparatively large curved shape.

Desirably, the weakened parts formed by cutting out the front parts of the left and right ends have openings which are covered up by cover members. Thus, by covering up the openings of the weakened parts with cover members, the strength of the weakened parts can be adjusted. Furthermore, by covering up the openings of the weakened parts with cover members, energy-absorbing members provided on the front surface of the bumper beam can be formed into a cross-sectional shape that is constant throughout the entirety of the energy-absorbing members. Energy can thereby be absorbed uniformly throughout the entirety of the energy-absorbing members.

In a preferred form, the high-strength parts comprise ridges formed by folding a sheet material.

The bumper beam may be formed by folding a sheet material into a B-shape in cross section.

### BRIEF DESCRIPTION OF THE DRAWINGS

Preferred embodiments of the present invention will be described in detail below, by way of example only, with reference to the accompanying drawings, in which:

FIG. 1 is a perspective view showing a vehicle body front structure according to the present invention;

FIG. 2 is a perspective view showing on an enlarged scale part of the vehicle body front structure shown in FIG. 1;

FIG. 3 is an enlarged view of section 3 of FIG. 2;

FIG. 4A is a cross-sectional view showing a side frame and an upper member along line 4a-4a of FIG. 3, and FIG. 4B is an exploded view showing the side frame and upper member of FIG. 4A;

FIG. 5 is a top plan view of the vehicle body front structure of FIG. 3;

FIG. 6A is a cross-sectional view taken along line 6A-6A of FIG. 2, and FIG. 6B is a cross-sectional view taken along line 6B-6B of FIG. 2;

FIG. 7 is a schematic view showing a state in which a comparatively large space is ensured in front of the left end of the energy-absorbing member of FIG. 3;

FIGS. 8A and 8B are schematic views illustrating an example in which impact energy is absorbed by the impact-absorbing structure of the present invention when the vehicle undergoes a collision in an offset manner at a low speed;

FIGS. 9A and 9B are schematic views illustrating an example in which the vehicle body front structure of the present invention undergoes a collision in an offset manner at a high speed;

FIG. 10 is a schematic view showing an example in which impact energy is absorbed by the vehicle body front structure of the present invention when the vehicle undergoes a collision in an offset manner at a high speed; and

FIG. 11 is a schematic view showing an example in which impact energy is absorbed by a conventional vehicle body front structure when the vehicle undergoes a collision in an offset manner.

### DETAILED DESCRIPTION OF THE PREFERRED EMBODIMENTS

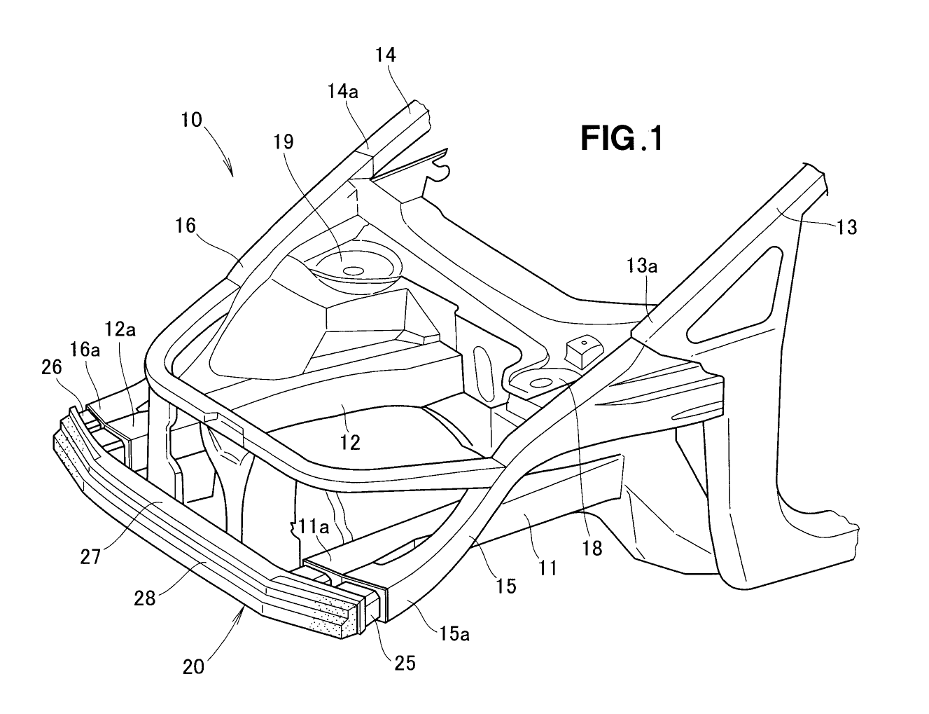

In FIG. 1, a vehicle body front structure 10 comprises left and right front side frames 11, 12 on the left and right sides of the front of the vehicle body, wherein a left front pillar 13 is provided above and to the rear of the left front side frame 11.

A left upper member 15 extends frontward from a bottom end 13a of the left front pillar 13, the left upper member 15 being disposed on the outside of the left front side frame 11. A right front pillar 14 is provided above and to the rear of the right front side frame 12, and a right upper member 16 extends frontward from a bottom end 14a of the right front pillar 14, the right upper member 16 being disposed on the outside of the right front side frame 12.

A left wheel housing 18 that covers a left front wheel (not shown) is provided between the left front side frame 11 and the left upper member 15.

A right wheel housing 19 that covers a right front wheel (not shown) is provided between the right front side frame 12 and the right upper member 16.

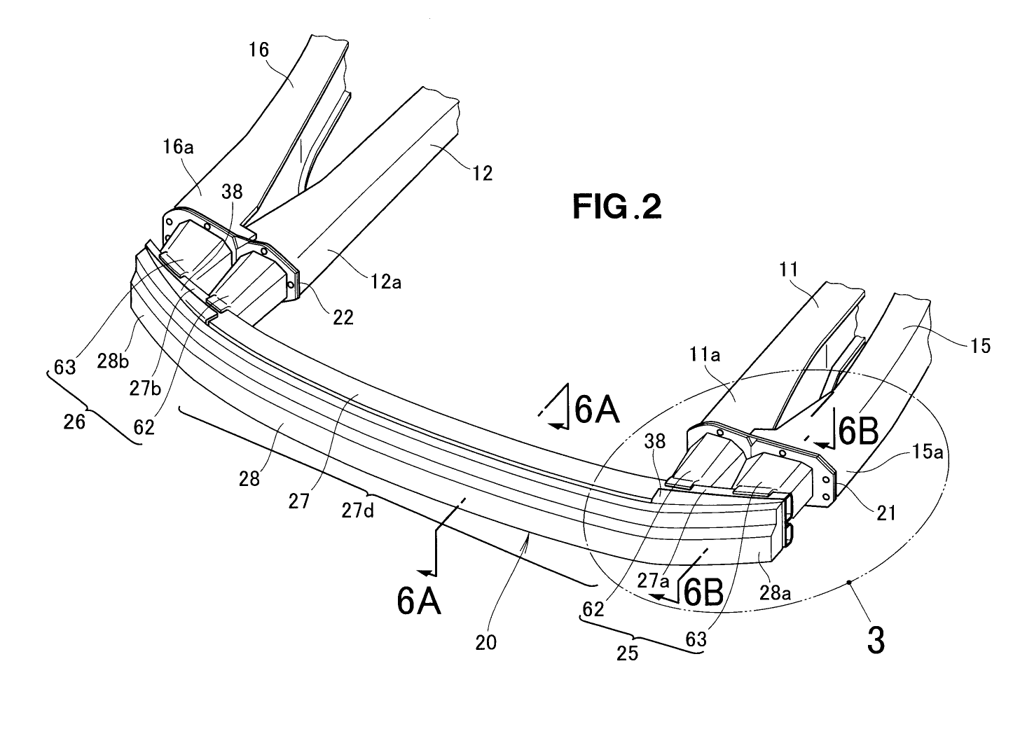

In the vehicle body front structure 10, a front end 11a of the left front side frame 11 and a front end 15a of the left upper member 15 are positioned so as to be parallel in the vehicle width direction, the front ends 11a, 15a being linked to each other; a front end 12a of the right front side frame 12 and a front end 16a of the right upper member 16 are arranged in the vehicle width direction, the front ends 12a, 16a being linked to each other; and an impact-absorbing member 20 is provided to the front ends 11a, 15a and front ends 12a, 16a, as shown in FIG. 2.

In the impact-absorbing member 20, a left impact-absorbing unit 25 is provided to the front ends 11a, 15a via a left mounting plate 21, a right impact-absorbing unit 26 is provided to the front ends 12a, 16a via a right mounting plate 22, a bumper beam 27 extends between the left and right impact-absorbing units 25, 26, and an energy-absorbing member 28 is provided to the bumper beam 27.

A left end 27a of the bumper beam 27 is mounted to the left impact-absorbing unit 25, and a right end 27b is mounted to the right impact-absorbing unit 26.

The left and right front side frames 11, 12 and the left and right upper members 15, 16 are bilaterally symmetrical members, and the right front side frame 12 and right upper member 16 are not described herein.

The left and right impact-absorbing units 25, 26 are bilaterally symmetric, and the structural components of the right impact-absorbing unit 26 are denoted by the same numerical symbols as those of the left impact-absorbing unit 25 and are not described.

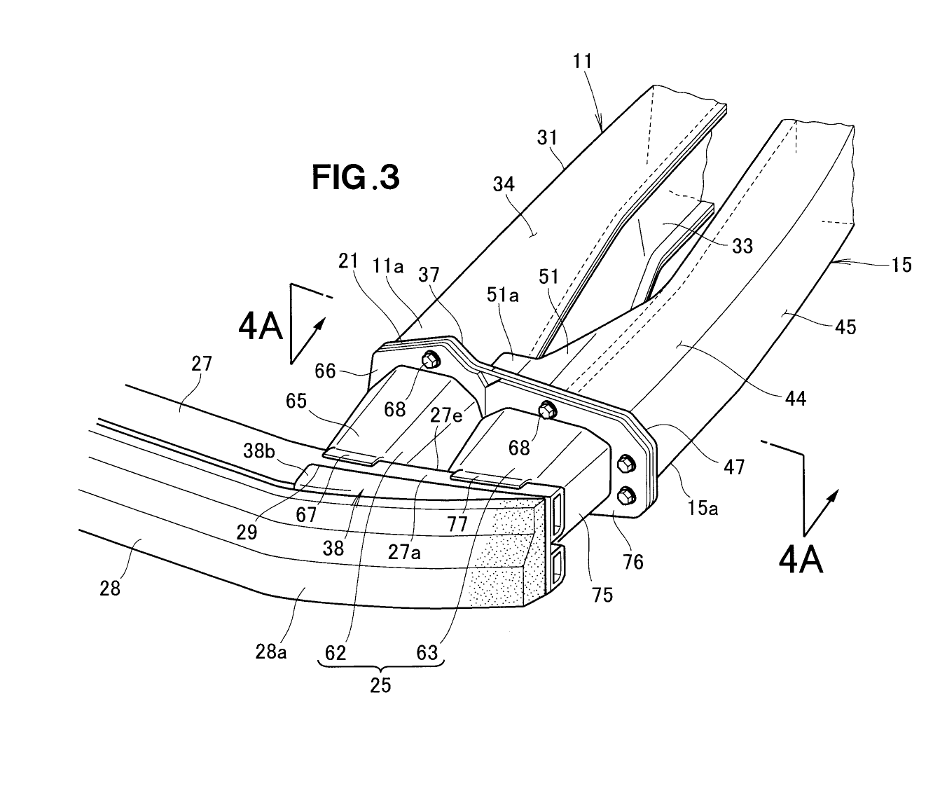

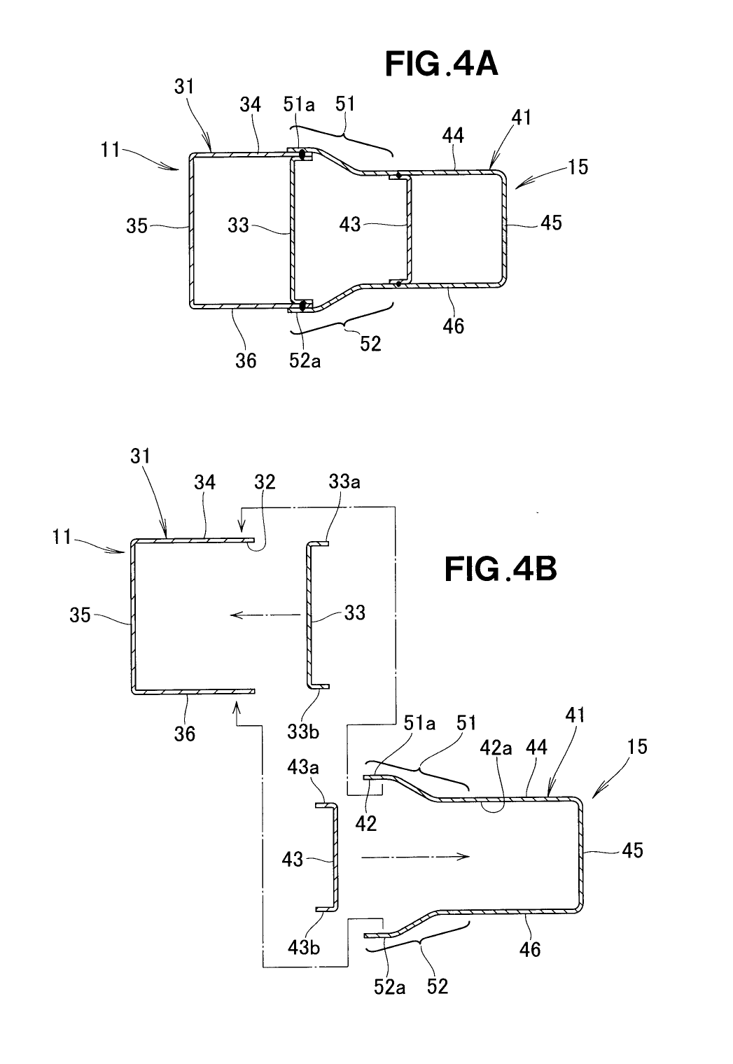

The left front side frame 11 extends in the longitudinal direction of the vehicle body, the left front side frame 11 has an opening 32 (FIG. 4B) that opens to the outside of the vehicle body, and the left front side frame 11 comprises a side frame member 31 having a U shape in cross section and a side external wall (outside wall) 33 having a U shape in cross section and being fitted with the opening 32 of the side frame member 31, as shown in FIGS. 3, 4A, and 4B.

The side frame member 31 comprises a top surface 34 disposed horizontally, an internal wall 35 extending downward from the internal side of the top surface 34, and a bottom surface 36 extending outward in the vehicle width direction from the bottom of the internal wall 35.

The side external wall 33 has top and bottom folded parts 33a, 33b provided along the opening 32 of the side frame member 31.

The left upper member 15 extends in the longitudinal direction of the vehicle body, the left upper member 15 has an opening 42 that opens to the inside of the vehicle body, and the left upper member 15 comprises an upper member component 41 having a U shape in cross section and an upper internal wall 43 having a U shape in cross section and being fitted with a middle opening 42a in the upper member component 41.

The upper member component 41 comprises a top surface 44 extending horizontally in the vehicle width direction, an external wall 45 extending downward from the external side of the top surface 44, and a bottom surface 46 extending inward in the vehicle width direction from the bottom of the external wall 45.

The upper internal wall 43 has top and bottom folded parts 43a, 43b provided along the middle opening 42a of the upper member component 41.

The top surface 44 is provided at the front end with a top protrusion 51 that protrudes toward the center of the vehicle body. A distal end 51a of the top protrusion 51 is joined by welding to the top surface 34 of the side frame member 31.

Similar to the top surface 44, the bottom surface 46 is provided at the front end with a bottom protrusion 52 that protrudes toward the center of the vehicle body.

The distal end 52a of the bottom protrusion 52 is joined by welding to the bottom surface 36 of the side frame member 31.

The front end 11a of the left front side frame 11 and the front end 15a of the left upper member 15 are thereby disposed in the vehicle width direction and are linked to each other.

A mounting piece 37 protrudes at the front end 11a of the left front side frame 11. A mounting piece 47 protrudes at the front end 15a of the left upper member 15.

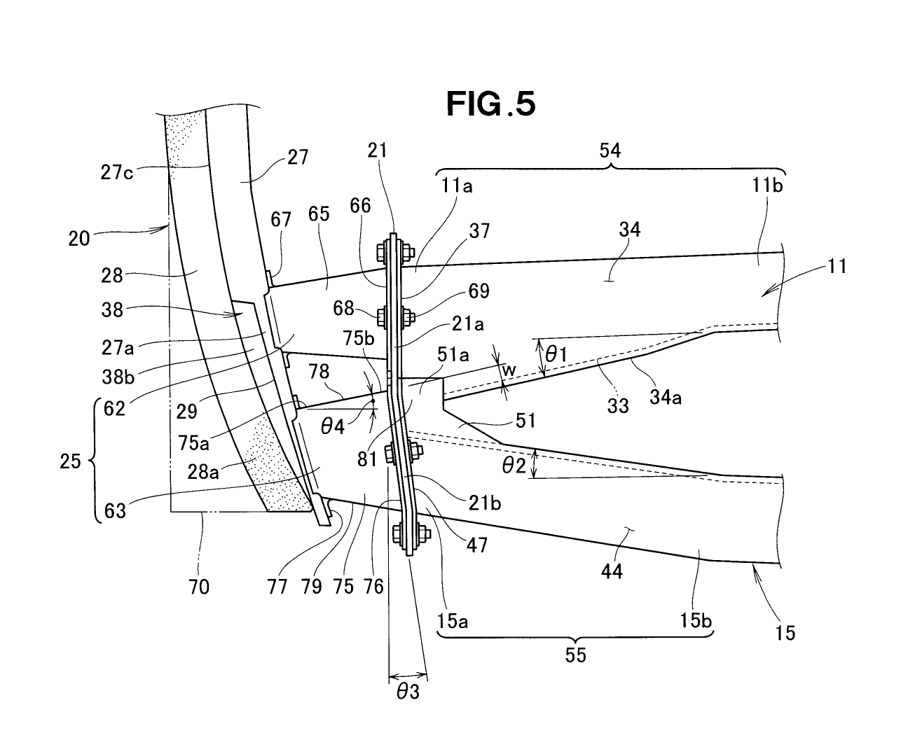

In the top surface 34 of the left front side frame 11, an outside edge 34a is formed at an inclination angle θ1 so as to be inclined progressively farther to the outside of the vehicle body (to the left upper member 15) from an approximate middle 11b of the left front side frame 11 toward the front end 11a, as shown in FIG. 5.

Consequently, the top surface 34 is formed so that the transverse width progressively increases toward the front end 11a from the approximate middle 12b.

Similar to the top surface 34, the bottom surface 36 shown in FIG. 4 also has an outside edge formed at an inclination angle θ1 so as to be inclined progressively farther to the outside of the vehicle body from the approximate middle to the front end.

The side external wall 33 is formed at an inclination angle θ1 so as to be inclined progressively farther to the outside of the vehicle body (to the left upper member 15) from the approximate middle 11b to the front end 11a along the outside edge 34a.

Within the left front side frame 11, the region from the approximate middle 11b to the front end 11a is hereinbelow described as a side front half 54.

The left upper member 15 is formed at an inclination angle θ2 so as to be gradually inclined toward the front of the vehicle body and toward the vehicle width center from an approximate middle 15b to the front end 15a.

Within the left upper member 15, the region from the approximate middle 15b to the front end 15a is hereinbelow described as an upper front half 55.

The side external wall 33 of the left front side frame 11 is provided to be inclined at the inclination angle θ1 in the side front half 54, and the upper front half 55 of the left upper member 15 is provided to be inclined at the inclination angle θ2. The side frame front end 11a and the upper member front end 15a are thereby disposed to be in proximity of each other.

In the front end 15a in the left upper member 15, a top protrusion 51 is provided on the top surface 44, and a bottom protrusion 52 (see FIG. 4) is provided on the bottom surface 46, as described above.

The top protrusion 51 is joined by welding to the top surface 34 of the side frame member 31. The distal end 52a of the bottom protrusion 52 is joined by welding to the bottom surface 36 of the side frame member 31. The front end 11a of the left front side frame 11 and the front end 15a of the left upper member 15 are thereby firmly linked together.

The left impact-absorbing unit 25 is provided via the left mounting plate 21 to the front end 11a of the left front side frame 11 and the front end 15a of the left upper member 15.

The left end 27a of the bumper beam 27 is mounted to the left impact-absorbing unit 25.

The left impact-absorbing unit 25 comprises an internal impact absorber 62 integrally mounted to the front end 11a of the left front side frame 11 via the left mounting plate 21, and an external impact absorber 63 integrally mounted to the front end 15a of the left upper member 15 via the left mounting plate 21.

The left mounting plate 21 has an internal mounting part 21a mounted to the front end 11a, and an external mounting part 21b mounted to the front end 15a.

The internal mounting part 21a is a plate mounted parallel to the vehicle width direction.

The external mounting part 21b is a plate inclined rearward at an angle θ3 in relation to the internal mounting part 21a.

Impact loads from oblique impact are thereby transmitted to the left front side frame 11 with greater efficiency.

The internal impact absorber 62 comprises a substantially rectangular internal tube 65, and also comprises an internal flange 66 at the rear end and an internal mounting piece 67 at the front end. The internal tube 65 is formed into a tapered shape in a plan view.

The internal flange 66 of the internal impact absorber 62 is mounted by a plurality of bolts 68 and a plurality of nuts 69 to the mounting piece 37 of the left front side frame 11 via the internal mounting part 21a of the left mounting plate 21. Consequently, the internal impact absorber 62 is provided in front of the left front side frame 11.

The external impact absorber 63 comprises a substantially rectangular external tube 75, and also comprises an external flange 76 at the rear end and an external mounting piece 77 at the front end.

The external impact absorber 63 is disposed at a predetermined distance outward from the internal impact absorber 62. The external flange 76 is mounted by a plurality of bolts 68 and a plurality of nuts 69 to the mounting piece 47 of the left upper member 15 via the external mounting part 21b of the left mounting plate 21. Consequently, the external impact absorber 63 is provided in front of the left upper member 15.

The left end 27a in the bumper beam 27 is formed so as to curve backward in consideration of the outward appearance and other features of the vehicle. Therefore, the left end 27a approaches the left mounting plate 21.

In view of this, the external mounting part 21b of the left mounting plate 21 is inclined rearward by an angle θ3 in relation to the internal mounting part 21a, as described above. A substantially constant gap can thereby be maintained between the left end 27a and the external mounting part 21b. An internal wall 78 and external wall 79 of the external impact absorber 63 can thereby be ensured to have substantially the same length, and a satisfactory crumple zone can be ensured in the external impact absorber 63.

The internal wall 78 of the external tube 75 of the external impact absorber 63 is formed to be inclined at an inclination angle θ4 from the front end 75a thereof to the rear end 75b.

The inclination angle θ4 is set to be substantially the same inclination angle as the inclination angle θ1 of the outside edge 34a of the left front side frame 11. Specifically, the relationship between the inclination angle θ4 and the inclination angle θ1 is θ4≈θ1.

In addition, the internal wall 78 of the external tube 75 is disposed to approach the center of the vehicle width in relation to the side external wall 33 of the left front side frame 11. An overlapping part 81 is thereby formed where the rear end 75b of the external tube 75 and the front end 11a of the left front side frame 11 partially overlap.

Specifically, the region of the rear end 75b of the external tube 75 that approaches the internal wall 78 overlaps the region of the front end 11a of the left front side frame 11 that approaches the side external wall 33, with the left mounting plate 21 located in between the two. The overlapping width of the region approaching the internal wall 78 and the region approaching the side external wall 33 is W.

The width W of the overlapping part 81 is designed so that when a collision occur in an offset manner with another vehicle that is misaligned to the left, for example, the impact load transferred rearward along the internal wall 78 of the external tube 75 is efficiently transmitted to the side external wall 33.

The left end 27a of the bumper beam 27 is welded to the internal mounting piece 67 of the internal impact absorber 62 and to the external mounting piece 77 of the external impact absorber 63.

In the bumper beam 27, the left end 27a curves rearward toward the vehicle body, and a concave weakened part 29 is formed in the left end 27a by cutting out the front surface.

An energy-absorbing member 28 is provided to the front surface 27c of the bumper beam 27. In the energy-absorbing member 28, a left end 28a is disposed along the concave weakened part 29 of the bumper beam 27.

In the bumper beam 27, the left end 27a curves rearward toward the vehicle body, and the front surface is formed into the concave weakened part 29, as described above.

Curving the left end 27a of the bumper beam 27 rearward toward the vehicle body, and forming the weakened part 29 in the left end 27a of the bumper beam 27 allows the left end 27a of the bumper beam 27 to approach the vehicle body even further. Consequently, the left and right ends of a bumper face (not shown) provided at the front of the bumper beam 27 can be made to approach the vehicle body. The bumper face is a member for forming the outward appearance of the vehicle body. Consequently, disposing the left end 28a of the energy-absorbing member 28 along the weakened part 29 allows the left end 28a to be considerably curved rearward toward the vehicle body. A comparatively large space 70 can thereby be ensured in front of the left end 28a of the energy-absorbing member 28; specifically, in front of the left end of the bumper face.

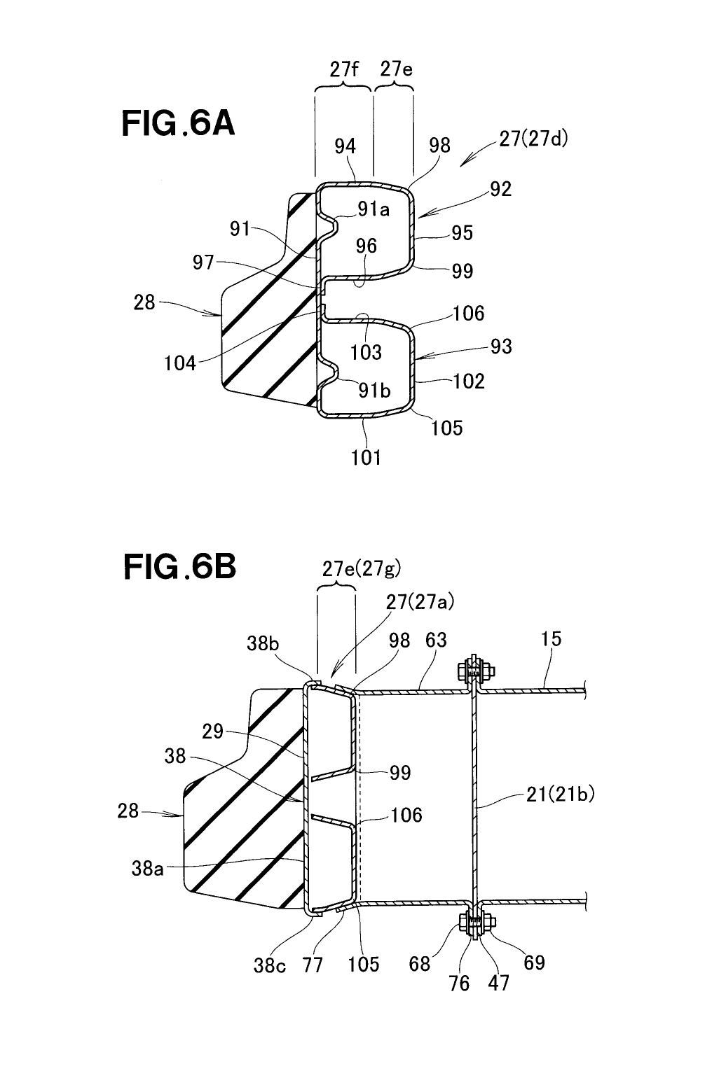

A left cover member 38 is provided between the weakened part 29 of the bumper beam 27 and the left end 28a of the energy-absorbing member 28. The left cover member 38 is formed into a substantial U shape at a front surface 38a and top and bottom surfaces 38b, 38c, as shown in FIG. 6B. The front surface 38a of the left cover member 38 is formed into a shape inclined to the rear of the vehicle body from the vehicle width center toward the exterior of the vehicle body.

Specifically, the left cover member 38 is formed into a substantially triangular shape in a plan view, so that the width dimension gradually decreases from the vehicle width center toward the exterior of the vehicle body. The strength of the weakened part 29 can be adjusted by covering up the opening of the weakened part 29 with the left cover member 38 as shown in FIG. 6B.

By covering up the opening of the weakened part 29 with the left cover member 38 as shown in FIG. 6B, the energy-absorbing member 28 provided on the front surface of the bumper beam 27 can be formed into a cross-sectional shape that is constant throughout the entire energy-absorbing member 28. Energy can thereby be absorbed uniformly throughout the entire energy-absorbing member 28.

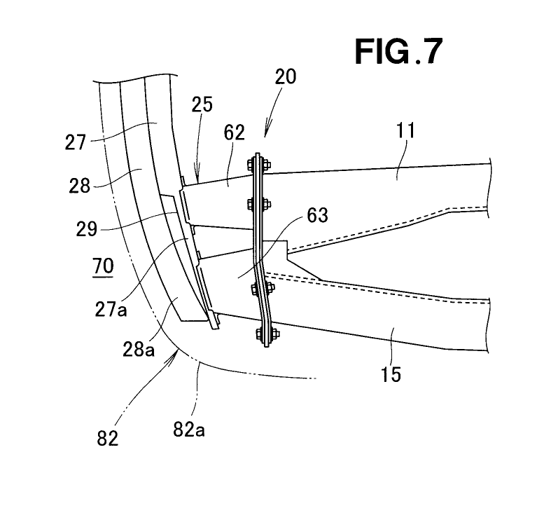

The reasons for ensuring a comparatively large space 70 in front of the left end of the bumper face are described in detail in FIG. 7.

In the bumper beam 27, the center 27d (FIG. 2) of the vehicle width direction comprises a front wall 91 disposed vertically, a top U-shaped part 92 provided in the top half of the front wall 91, and a bottom U-shaped part 93 provided in the bottom half of the front wall 91, as shown in FIG. 6A.

The front wall 91 has a top rib 91a protruding rearward in the vicinity of the top end, and a bottom rib 91b protruding rearward in the vicinity of the bottom end.

The top U-shaped part 92 has a top wall 94 folded rearward from the top end of the front wall 91, a top rear wall 95 folded downward from the rear end of the top wall 94, a top center 96 folded forward from the bottom end of the top rear wall 95, and a top joining piece 97 folded downward from the front end of the top center 96 and joined to the center of the front wall 91.

A top ridge 98 is formed by the rear end of the top wall 94 and the top end of the top rear wall 95, and a top center ridge 99 is formed by the bottom end of the top rear wall 95 and the rear end of the top center 96.

The top ridge 98 is hereinbelow referred to as the “top high-strength part,” and the top center ridge 99 is referred to as the “top center high-strength part (high-strength part).”

The bottom U-shaped part 93 has a bottom wall 101 folded rearward from the bottom end of the front wall 91, a bottom rear wall 102 folded upward from the rear end of the bottom wall 101, a bottom center 103 folded forward from the top end of the bottom rear wall 102, and a bottom joining piece 104 folded upward from the front end of the bottom center 103 and joined to the center of the front wall 91.

A bottom ridge 105 is formed at the border between the bottom wall 101 and the bottom rear wall 102, and a bottom center ridge 106 is formed at the border between the bottom rear wall 102 and the bottom center 103.

The bottom ridge 105 is hereinbelow referred to as the “bottom high-strength part,” and the bottom center ridge 106 is referred to as the “bottom center high-strength part.” Consequently, the top high-strength part 98, the top center high-strength part 99, the bottom high-strength part 105, and the bottom center high-strength part 106 are provided to the rear half 27e of the bumper beam 27.

In the left end 27a of the bumper beam 27, the front half 27f (FIG. 6A) is removed, and the weakened part 29 is formed in the removed area, as shown in FIG. 6B. Consequently, within the rear half 27e, the top high-strength part 98, the top center high-strength part 99, the bottom high-strength part 105, and the bottom center high-strength part 106 are also formed in the end rear half 27g corresponding to the left end 27a.

In the end rear half 27g of the left end 27a, the external front mounting piece 77 of the external impact absorber 63 is joined to the external side of the vehicle width direction, as shown in FIG. 3.

In the end rear half 27g of the left end 27a, the internal mounting piece 67 of the internal impact absorber 62 is joined to the internal side of the vehicle width direction, as shown in FIG. 3.

Consequently, the end rear half 27g of the left end 27a is supported by the internal and external impact absorbers 62, 63. The internal and external impact absorbers 62, 63 can thereby be firmly integrated with the end rear half 27g having the high-strength parts 98, 99, 105, 106.

The right end 27b of the bumper beam 27 shown in FIG. 2 is bilaterally symmetrical to the left end 27a, and the right end 27b is not described herein.

The right end 28b of the energy-absorbing member 28 shown in FIG. 2 is bilaterally symmetrical to the left end 28a, and the right end 28b is not described herein.

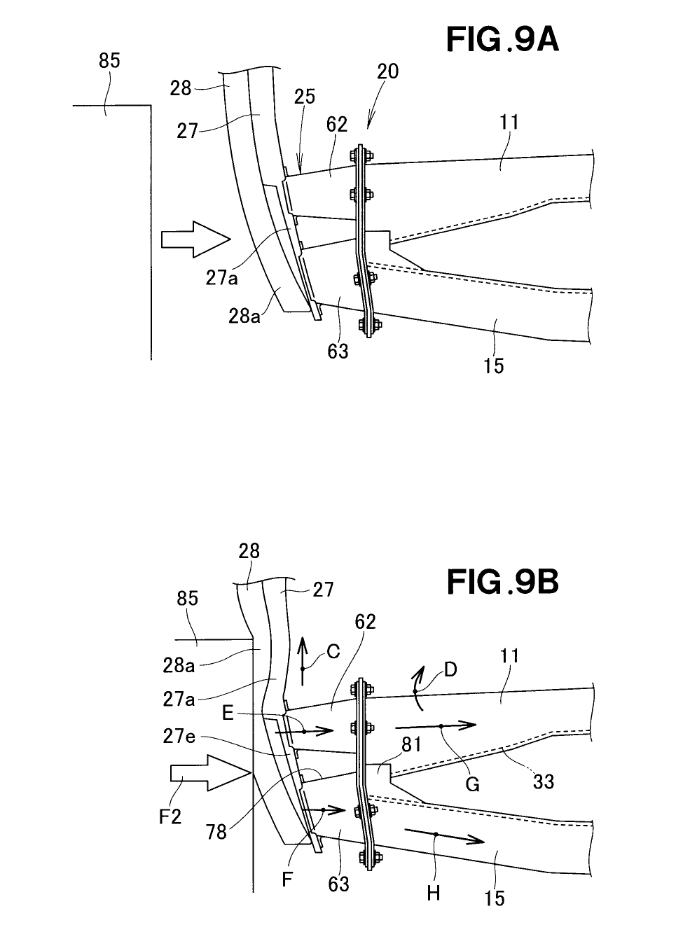

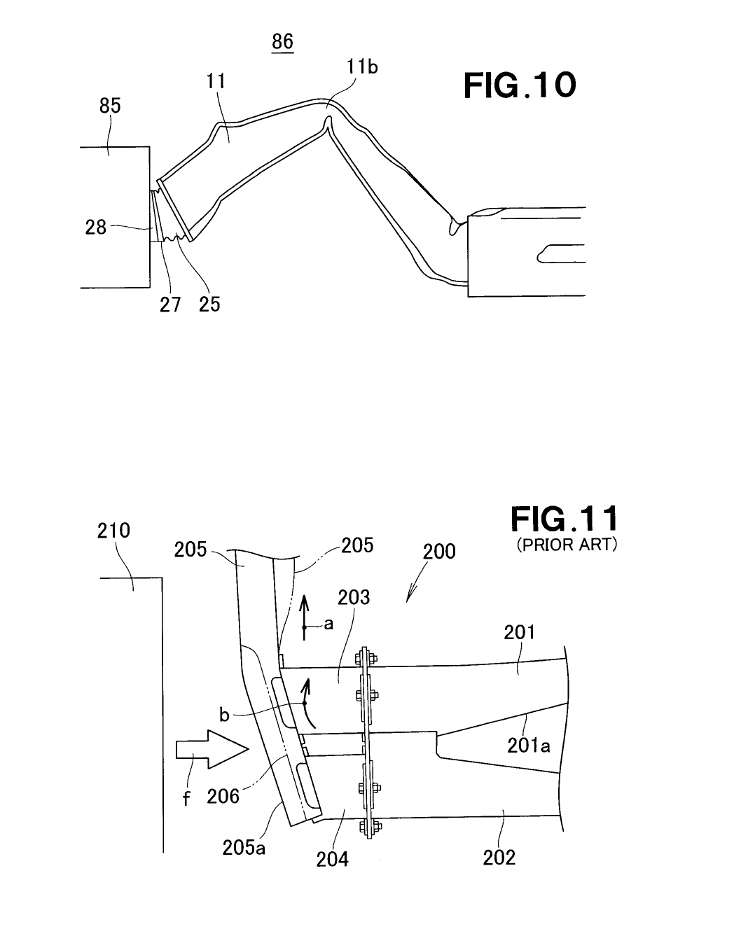

The reasons for supporting the internal and external impact absorbers 62, 63 via the rear half 27e are described in detail in FIGS. 9 and 10.

Next, the reasons for ensuring a comparatively large space 70 in front of the left end 28a of the energy-absorbing member 28; specifically, in front of the left end of the bumper face, are described with reference to FIG. 7.

In FIG. 7, the left end 27a of the bumper beam 27 is bent toward the rear of the vehicle body, and the weakened part 29 is formed on the front surface of the left end 27a.

The energy-absorbing member 28 is provided on the front surface of the bumper beam 27, whereby the left end 28a is disposed along the weakened part 29.

Consequently, the left end 28a of the energy-absorbing member 28 can be considerably bent rearward toward the vehicle body. A comparatively large space 70 can thereby be ensured in front of the left end 28a of the energy-absorbing member 28; specifically, in front of the left end of the bumper face. Therefore, a left front corner 82a of the vehicle front (bumper face) 82 can be formed into a comparatively large curving shape, and the outward appearance of the vehicle can be improved even further.

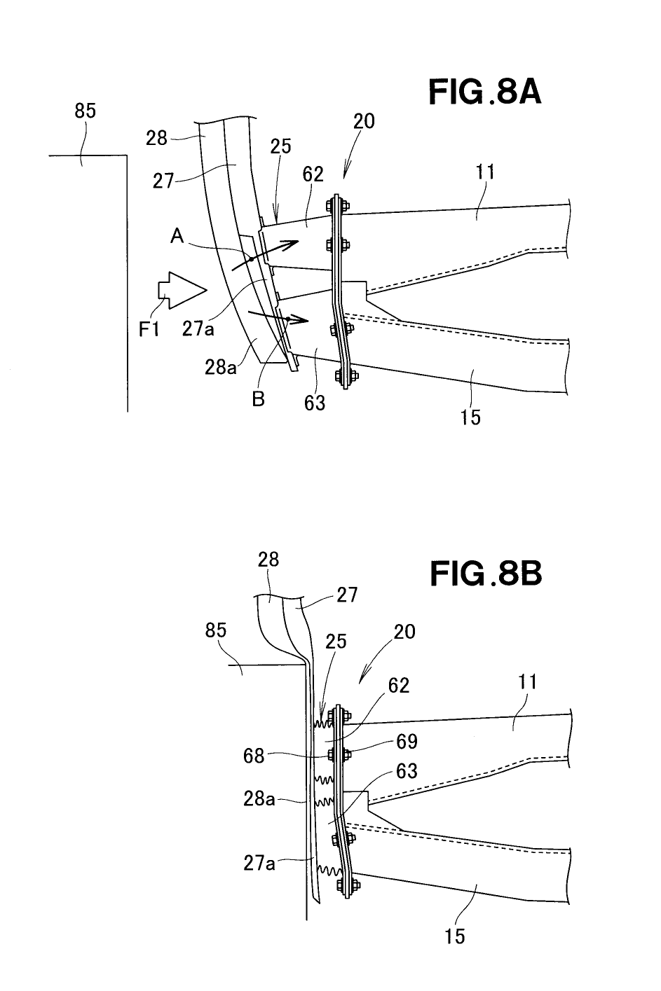

Next, an example will be described with reference to FIGS. 8A and 8B in which another vehicle collides in an offset manner at a low speed (a minor collision) with the impact-absorbing member 20 of the vehicle body front structure 10.

In FIG. 8A, another vehicle 85, being misaligned to the left of the impact-absorbing member 20, collides in an offset manner (an offset minor collision) with the left end 28a of the energy-absorbing member 28.

An impact load F1 generated by the minor collision (low-speed collision) is transmitted to the left impact-absorbing unit 25 via the left end 28a of the energy-absorbing member 28 and the left end 27a of the bumper beam 27. Specifically, an impact load is transmitted as shown by the arrow A to the internal impact absorber 62, and an impact load is transmitted as shown by the arrow B to the external impact absorber 63.

In FIG. 8B, part of the impact load F1 is absorbed by the deformation of the left end 28a of the energy-absorbing member 28 and the left end 27a of the bumper beam 27. The remainder of the impact load is absorbed by the buckling of the left impact-absorbing unit 25 (the internal impact absorber 62 and the external impact absorber 63).

Thus, in the event of a minor collision, the left front side frame 11 and the left upper member 15 do not deform, and the impact load F1 (i.e., the impact energy) can be absorbed. Consequently, an offset minor collision can be subsequently dealt with in a simple process of removing the plurality of bolts 68 and replacing the energy-absorbing member 28, the bumper beam 27, and the left impact-absorbing unit 25.

When a minor collision affects the entire surface of the vehicle body front structure 10, the impact load can be absorbed in the following manner.

When another vehicle 85 collides with the entire surface of the vehicle body front structure 10, first, the energy-absorbing member 28 shown in FIG. 2 deforms to absorb part of the impact load.

Next, the center 27d (FIG. 2) of the bumper beam 27 curved toward the front of the vehicle body deforms to the rear of the vehicle body to absorb the remainder of the impact load. The bumper beam 27 is pushed in between the left and right internal impact absorbers 62, 62.

Next, the left and right weakened parts 29, 29 of the bumper beam 27 and the left and right impact-absorbing units 25, 26 (FIG. 2) deform (crumple) to absorb the remainder of the impact load.

In this state, the bumper beam 27 deforms in a straight line substantially parallel to the vehicle width direction, and incomplete crumpling of the left and right weakened parts 29, 29 of the bumper beam 27 can be prevented. A large effective stroke for absorbing the impact load can thereby be ensured, and this design can be effectively applied to the impact-absorbing structure of a vehicle having a short vehicle body front part.

Next, an example in which another vehicle collides in an offset manner at a high speed with the impact-absorbing member 20 of the vehicle body front structure 10 will be described with reference to FIGS. 9 and 10.

In FIG. 9A, another vehicle 85, being misaligned to the left of the impact-absorbing member 20, collides in an offset manner (an offset high-speed collision) with the left end 28a of the energy-absorbing member 28.

In FIG. 9B, the other vehicle 85 collides in an offset manner (high-speed collision), whereby the left end 28a of the energy-absorbing member 28 and the left end 27a of the bumper beam 27 deform.

The deformation of the left end 27a of the bumper beam 27 causes an impact load to act as shown by the arrow C on the left end 27a toward the vehicle width center. The impact load acts on the left front side frame 11 via the internal impact absorber 62, and the left front side frame 11 undergoes bending deformation as shown by the arrow D.

The high-strength parts 98, 99, 105, 106 (see FIG. 6B) are provided to the end rear half 27g of the bumper beam 27, and the end rear half 27g is supported by the internal and external impact absorbers 62, 63. Consequently, the internal and external impact absorbers 62, 63 are firmly integrated with the end rear half 27g having the high-strength parts 98, 99, 105, 106. The bending deformation of the left front side frame 11 as shown by the arrow D can thereby be inhibited.

The impact load F2 generated by the high-speed collision is transmitted as shown by the arrow E to the internal impact absorber 62, and is also transmitted as shown by the arrow F to the external impact absorber 63, via the left end 28a of the energy-absorbing member 28 and the left end 27a of the bumper beam 27.

Furthermore, the impact load transmitted to the internal impact absorber 62 is transmitted as shown by the arrow G to the left front side frame 11, and the impact load transmitted to the external impact absorber 63 is transmitted as shown by the arrow H to the left upper member 15.

In FIG. 10, the left front side frame 11 can be satisfactorily deformed (specifically, satisfactorily deformed so as to fold) by preventing the left front side frame 11 from undergoing bending deformation as shown by the arrow D (see FIG. 9B). The approximate middle 11b of the left front side frame 11 can thereby be deformed in a dogleg shape, and the impact load can be satisfactorily absorbed.

Thus, the dogleg-shaped deformation of the left front side frame 11 makes a crushable zone possible in which the engine compartment 86 is effectively collapsed. A sufficient amount of deformation can thereby be ensured in the left front side frame 11, and deformation in the passenger cabin behind the engine compartment 86 can be suppressed.

When the entire surface of the vehicle body front structure 10 undergoes a high-speed collision, the same action and effects as those described with reference to FIGS. 9 and 10 are obtained.

In the above embodiment, an example was described in which the front half 27f was removed from the left end 27a of the bumper beam 27 and a weakened part 29 was provided, but the present invention is not limited to this design, and another possibility is for the front half 27f of the left end 27a to crumple and for the weakened part 29 to be formed.

The vehicle body front structure of the present invention is suitable for application in a vehicle in which impact absorbers are provided to the front side frames, and bumper beams are provided to the impact absorbers.

Obviously, various minor changes and modifications of the present invention are possible in light of the above teaching. It is therefore to be understood that within the scope of the appended claims the invention may be practiced otherwise than as specifically described.

What is claimed is:

1. A vehicle body front structure comprising:
left and right front side frames extending in a longitudinal direction of a vehicle body;
left and right front pillars disposed above the respective left and right front side frames and extending rearwardly;
left and right upper members extending forward from the respective left and right front pillars and positioned outside the respective left and right front side frames;
left and right internal impact absorbers and left and right external impact absorbers provided at respective front ends of the left and right front side frames and the left and right upper members; and
a bumper beam provided at front ends of the left and right internal and external impact absorbers,
wherein the bumper beam includes:
left and right ends curved rearwardly of the vehicle body;
high-strength parts provided at rear halves of the left and right ends; and
weakened parts formed at front parts of the left and right ends and extending outwardly from areas corresponding to internal walls of the left and right internal impact absorbers, and
wherein the high-strength parts of the left and right ends are supported by the internal impact absorbers and the external impact absorbers.

2. The vehicle body front structure of claim 1, wherein the weakened parts are formed by cutting out the front parts of the left and right ends.

3. The vehicle body front structure of claim 2, wherein the weakened parts formed by cutting out the front parts of the left and right ends have openings, and the openings are covered up by cover members.

4. The vehicle body front structure of claim 1, wherein the high-strength parts comprise ridges formed by folding a sheet material.

5. The vehicle body front structure of claim 1, wherein the bumper beam is formed by folding a sheet material into a B-shape in cross section.
